(19) United States
(12) Patent Application Publication
(10) Pub. No.: US 2025/0252696 A1
(43) Pub. Date: Aug. 7, 2025

(54) INFORMATION PROCESSING DEVICE, INFORMATION PROCESSING METHOD, AND RECORDING MEDIUM

(71) Applicant: SONY GROUP CORPORATION, TOKYO (JP)

(72) Inventors: NAOKI OKAMOTO, TOKYO (JP); KEIICHIRO TANIGUCHI, TOKYO (JP)

(21) Appl. No.: 18/856,165

(22) PCT Filed: Apr. 4, 2023
(86) PCT No.: PCT/JP2023/013886

§ 371 Date: Oct. 11, 2024

(30) Foreign Application Priority Data
Apr. 20, 2022 (JP) 2022-069277

(51) Int. Cl. G06T 19/20; G06T 15/10; G06T 19/00

(52) U.S. Cl. CPC G06T 19/20; G06T 15/10; G06T 19/006; G06T 2219/2016

(57) ABSTRACT

The present disclosure relates to an information processing device, an information processing method, and a recording medium that are capable of reducing adverse effects caused by a real object occluding a virtual object.

Provided is an information processing device including: a position information acquisition unit that acquires first position information indicating a position of a first user and second position information indicating a position of a second user; a control unit that controls, based on a corresponding position in a real space of a virtual object viewed by the first user and the position indicated by the second position information, a form change of the virtual object; and an image output unit that outputs a stereoscopic image to be displayed to the first user and the second user based on the form change of the virtual object. The present disclosure can be applied, for example, to a device that constitutes a CAVE system.

### TECHNICAL FIELD

The present disclosure relates to an information processing device, an information processing method, and a recording medium, and particularly relates to an information processing device, an information processing method, and a recording medium that are capable of reducing adverse effects caused by a real object occluding a virtual object.

### BACKGROUND ART

A system that displays an image on walls around an experiencer (user) so that the user experiences virtual reality as if the user be in a computer graphics (CG) space is called a CAVE. While typical CAVE systems are mainly used by one person, CAVE systems that allow a plurality of users to experience has been proposed in recent years.

PTL 1 discloses a technology that detects the position of a user in a box-shaped projection space by a position sensor, and corrects the detection value of the position sensor according to the distance between the position sensor and the user.

### CITATION LIST

### Patent Literature

[PTL 1]

JP 2004-12626 A

### SUMMARY

### Technical Problem

When a plurality of users experience a CAVE system, if there is a real object between a user and a virtual object, the virtual object, which should appear in front of the real object, will be occluded, causing various problems. However, conventional technologies, including the technology disclosed in PTL 1, do not provide sufficient measures to prevent occlusion of virtual objects when experienced by a plurality of users, and there is therefore a need for technology to reduce such adverse effects caused by real objects occluding virtual objects.

The present disclosure has been made in view of such circumstances, and aims at making it possible to reduce adverse effects caused by a real object occluding a virtual object.

### Solution to Problem

An information processing device of one aspect of the present disclosure is an information processing device including: a position information acquisition unit that acquires first position information indicating a position of a first user and second position information indicating a position of a second user; a control unit that controls, based on a corresponding position in a real space of a virtual object viewed by the first user and the position indicated by the second position information, a form change of the virtual object; and an image output unit that outputs a stereoscopic image to be displayed to the first user and the second user based on the form change of the virtual object.

An information processing method and a recording medium according to one aspect of the present disclosure are an information processing method and a recording medium, each corresponding to the information processing device according to one aspect of the present disclosure.

In an information processing device, information processing method, and recording medium of one aspect of the present disclosure, first position information indicating a position of a first user and second position information indicating a position of a second user are acquired; based on a corresponding position in a real space of a virtual object viewed by the first user and the position indicated by the second position information, a form change of the virtual object is controlled; and a stereoscopic image to be displayed to the first user and the second user is output based on the form change of the virtual object.

The information processing device according to one aspect of the present disclosure may be an independent device or may be an internal block in which one device is configured.

### BRIEF DESCRIPTION OF DRAWINGS

FIG. 1 is a diagram illustrating an example of information sharing among a plurality of users in a CAVE system.

FIG. 2 is a diagram illustrating an example in which a virtual object is occluded by a real object.

FIG. 3 illustrates an example of an ideal experience.

FIG. 4 illustrates an example of an experience when an occlusion problem occurs.

FIG. 5 is a diagram illustrating an example of control for a virtual object being shared among users.

FIG. 6 is a diagram illustrating a configuration example of an embodiment of a CAVE system to which the present disclosure is applied.

FIG. 7 is a block diagram illustrating a configuration example of an information processing device in FIG. 6.

FIG. 8 is a flowchart illustrating a flow of processing of the CAVE system.

FIG. 9 is a diagram illustrating a first example of a method of identifying a virtual object viewed by a user.

FIG. 10 is a diagram illustrating a second example of a method of identifying a virtual object viewed by a user.

FIG. 11 is a diagram illustrating first processing of determining whether a virtual object is occluded by a real object.

FIG. 12 is a diagram illustrating second processing of determining whether the virtual object is occluded by the real object.

FIG. 13 is a diagram illustrating another example of the second processing of determining whether the virtual object is occluded by the real object.

FIG. 14 is a diagram illustrating third processing of determining whether the virtual object is occluded by the real object.

FIG. 15 is a diagram illustrating fourth processing of determining whether the virtual object is occluded by the real object.

FIG. 16 is a diagram illustrating an occluded region and a non-occluded region.

FIG. 17 is a diagram illustrating an example of movement of a virtual object from an occluded region to a non-occluded region.

FIG. 18 is a diagram illustrating an example of a movement pattern of a virtual object.

FIG. 19 is a diagram illustrating an example of movement of the virtual object with varying speed.

FIG. 20 is a diagram illustrating an example of fading out the virtual object.

FIG. 21 is a diagram illustrating a first example of switching between movement and avoidance of the virtual object.

FIG. 22 is a diagram illustrating a second example of switching between movement and avoidance of the virtual object.

FIG. 23 is a diagram illustrating a third example of switching between movement and avoidance of the virtual object.

FIG. 24 is a diagram illustrating an example in which a virtual object is changed from stereoscopic displaying to planar displaying.

FIG. 25 is a diagram illustrating an example of displaying notification information for informing of a virtual object.

FIG. 26 is a diagram illustrating an example of a warning displayed when a virtual object cannot be moved.

FIG. 27 is a diagram illustrating an example of moving a virtual object when the virtual object can be moved.

FIG. 28 is a block diagram illustrating a configuration example of computer hardware.

### DESCRIPTION OF EMBODIMENTS

### Overview of System

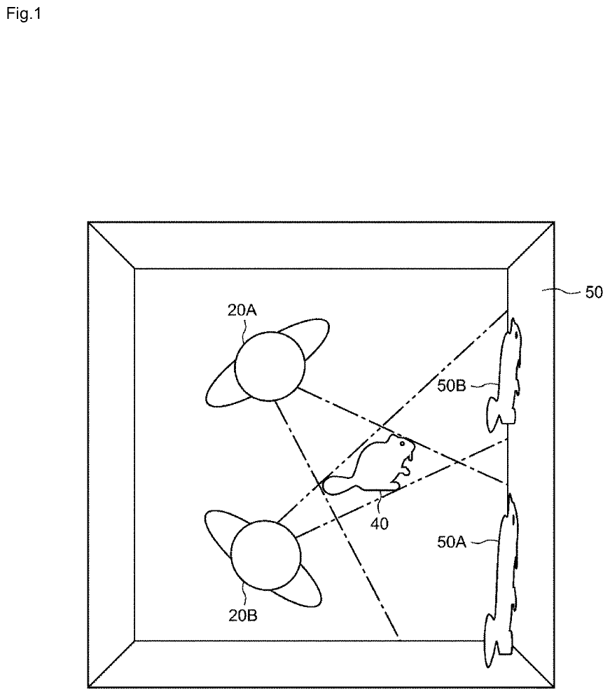

FIG. 1 is a diagram illustrating an example of information sharing among a plurality of users in a CAVE system. FIG. 1 illustrates a view (top view) of a real space surrounded by six sides: four walls, a floor, and a ceiling, when viewed from above.

In FIG. 1, two users, a user 20A and a user 20B, stereoscopically view a virtual object 40 projected onto a projection surface 50. Specifically, the user 20A views the virtual object 40 stereoscopically through a virtual object 50A projected onto the projection surface 50 within a field of view indicated by dashed dotted lines. On the other hand, the user 20B views the virtual object 40 stereoscopically through a virtual object 50B projected onto the projection surface 50 within a field of view indicated by two-dot chain lines.

In this way, a CAVE system displays an image on the walls around the users so that the users experience virtual reality as if they be in a CG space. In a CAVE system, for example, a virtual object can be viewed stereoscopically through binocular parallax provided by, for example, liquid crystal shutter glasses, and motion parallax provided by head position measurement.

When a plurality of users experience a CAVE system, there is a problem with a virtual object that is displayed protruding from a projection screen, in which if a real object (e.g., another user or another object) is located between the projection screen and the user, the virtual object that should appear in front of the real object will be occluded and become invisible.

Such occlusion of a virtual object can hinder information presentation and reduce the sense of immersion in the CAVE system. For example, as illustrated in FIG. 1, when the user 20A and the user 20B share the virtual object 40, if the virtual object 40 is located between the user 20A and the user 20B, their bodies will occlude the projection surface, resulting in failure to communicate properly.

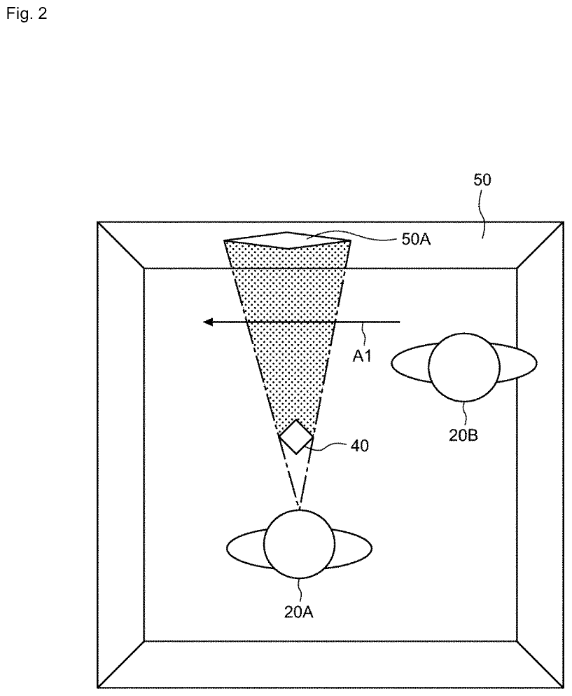

FIG. 2 is a diagram illustrating an example in which a virtual object is occluded by a real object. In FIG. 2, a user 20A stereoscopically views a virtual object 40 through a virtual object 50A projected onto a projection surface 50. At this time, in the real space, when a user 20B walks in the direction of an arrow A1 in the figure and moves between the user 20A and the projection surface 50, the virtual object 40, which would otherwise appear in front of the user 20B, will be occluded by the user 20A and become invisible to the user 20A.

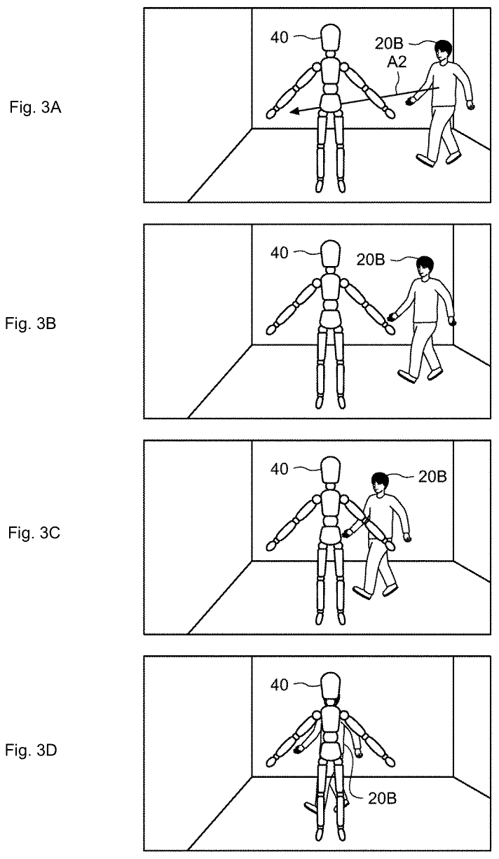

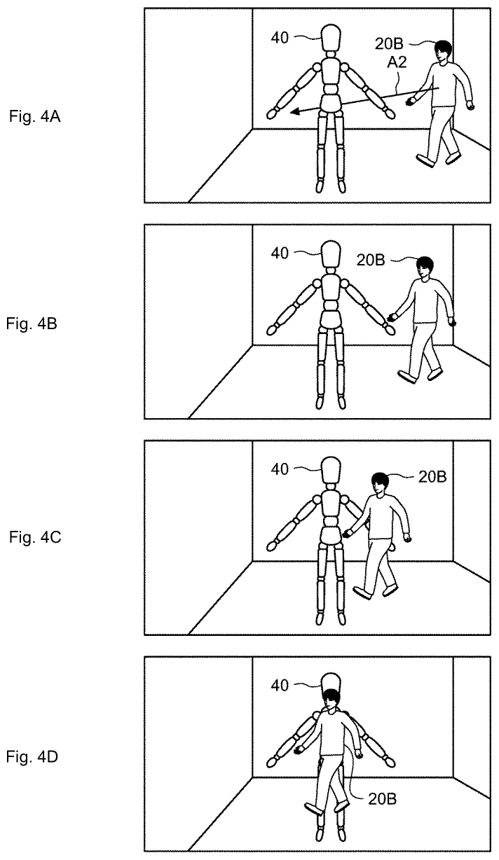

In FIG. 3, A to D now present a time series of the user 20B moving in the real space from right to left as indicated by an arrow A2 in the figure. From the perspective of user 20A, it would be ideal for the user 20B to pass behind the virtual object 40 such as an avatar without occluding the virtual object 40. However, in current CAVE systems, as illustrated in A to D of FIG. 4, the movement of the user 20B causes the virtual object 40 to be occluded, resulting in the problem of occlusion. Such occlusion of a virtual object by a real object causes a breakdown in the stereoscopic effect experienced by the user.

Therefore, in a CAVE system to which the present disclosure is applied, when a virtual object is occluded by a real object, the position and display form of the virtual object are changed based on the user's positional relationship and the attributes of the content and object, thereby reducing the adverse effects caused by the real object occluding the virtual object. For example, it is possible to prevent users' information sharing from being hindered and the sense of immersion from being reduced, which are due to a real object occluding a virtual object.

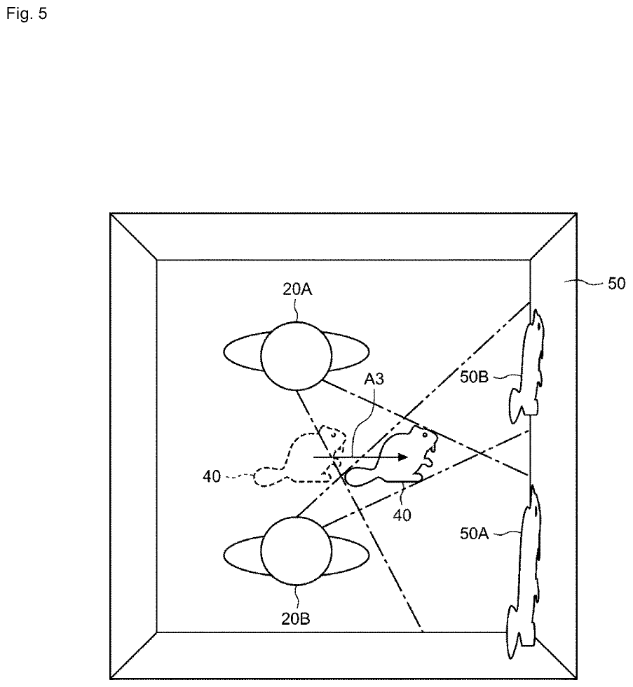

FIG. 5 is a diagram illustrating an example of control for a virtual object being shared among users in the CAVE system to which the present disclosure is applied. In FIG. 5, when a user 20A and a user 20B who use the CAVE system share a virtual object 40, if the virtual object 40 is located between the user 20A and the user 20B, the virtual object 40 is translated from the position of a dashed line to the position of a solid line, as indicated by an arrow A3 in the figure.

As a result, the virtual object 40 moves to a location where it is not occluded by their bodies, allowing both the user 20A and the user 20B to view the virtual object 40. Specifically, the user 20A views the virtual object 40 stereoscopically through a virtual object 50A projected onto the projection surface within a field of view indicated by dashed dotted lines. On the other hand, the user 20B views the virtual object 40 stereoscopically through a virtual object 50B projected onto the projection surface within a field of view indicated by two-dot chain lines. In this way, in the CAVE system to which the present disclosure is applied, when a real object occludes a virtual object, the adverse effects caused by the real object occluding the virtual object can be reduced by performing control such as moving the virtual object.

### System Configuration

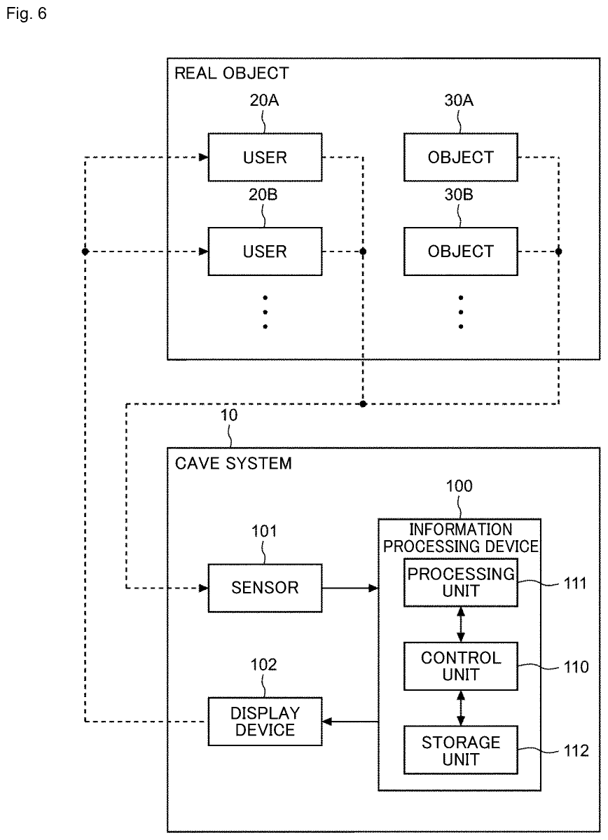

FIG. 6 is a diagram illustrating a configuration example of the CAVE system to which the present disclosure is applied.

The CAVE system 10 is a system that displays an image on the walls around users so that the users experience virtual reality as if they be in a CG space. The system refers to a logical collection of a plurality of devices.

A user 20A and a user 20B are users who experience the CAVE system 10 in a real space (such as a room) surrounded by six sides: four walls, a floor, and a ceiling, for example. An example is illustrated in which two users, the user 20A and the user 20B, participate. However, more users may participate as a plurality of users.

Objects 30A and 30B are objects (things) that are present in the real space, and users (people) such as the user 20A and the user 20B are excluded. The number of objects present in the real space is not limited to two, the object 30A and the object 30B, and one or more objects may be present in the real space, or no objects other than the users may be present. In the example of FIG. 6, users such as the user 20A and the user 20B and objects such as the object 30A and the object 30B are present as real objects in the real space.

The CAVE system 10 includes an information processing device 100, a sensor 101, and a display device 102. The information processing device 100 includes a computer such as a personal computer (PC), a server, or a dedicated device. The information processing device 100 includes a control unit 110, a processing unit 111, and a storage unit 112.

The control unit 110 includes a processor such as a central processing unit (CPU). The control unit 110 controls the operation of each unit.

The processing unit 111 performs various types of processing for implementing the CAVE under the control of the control unit 110. The functions of the processing unit 111 are implemented by the control unit 110 executing a program. Alternatively, all or part of the functions of the processing unit 111 may be implemented by dedicated hardware.

The storage unit 112 is configured as an auxiliary storage device such as a hard disk drive (HDD) or a semiconductor memory. The storage unit 112 records therein various types of data, various types of information, programs, and so on, required to implement the CAVE. The control unit 110 records various types of data and various types of information in the storage unit 112 and reads various types of data and various types of information recorded in the storage unit 112.

The sensor 101 is a sensor that senses spatial information, time information, and the like, and acquires sensor information related to real objects such as the users and objects that are present in the real space. For example, the sensor 101 is configured as a real object distance measurement sensor that acquires distance measurement information of a real object.

Specifically, as the sensor 101, sensors can be used such as a magnetic sensor, an image sensor, a time of flight (ToF) sensor, an RGB-depth (RGBD) sensor, a light detection and ranging (LiDAR), an inertial measurement unit (IMU), and a tilt sensor. Alternatively or additionally, technologies may also be used such as simultaneous localization and mapping (SLAM), virtual reality (VR) tracking, and marker detection. A gaze estimation sensor may also be used such as an infrared sensor. Alternatively, the sensor information may be acquired using a device such as a smartphone carried by the user.

The sensor information related to the real objects (such as the users and objects) acquired by the sensor 101 is output to the information processing device 100. The information processing device 100 performs processing required to implement the CAVE based on the sensor information input from the sensor 101. The information processing device 100 generates image data for a stereoscopic image based on the result of the processing, and outputs the image data to the display device 102.

The display device 102 displays the stereoscopic image based on the image data input from the information processing device 100. The display device 102 includes a projector for providing six-side projection, and the like. For example, by using a projector for providing six-side projection, an image can be projected and displayed on six sides, including four walls, a floor, and a ceiling, which serve as projection surfaces.

However, the number of projection surfaces is not limited to six sides, and for three sides such as two walls and the floor, or five sides such as four walls and the floor, as projection surfaces used to implement the CAVE, a projector for providing a projection suitable to the projection surfaces can be used. Furthermore, the number of projection surfaces is not limited to six, three, or five sides, and a single side or curved projection may be provided. For a single surface, a television receiver (three-dimensional display) for displaying stereoscopic images may be used.

Users such as the user 20A and the user 20B can stereoscopically view a displayed stereoscopic image (e.g., a stereoscopic image projected onto a projection surface). The stereoscopic view can be realized by various methods, such as a method using liquid crystal shutter glasses, a method using a lenticular lens, a method using a plurality of projectors, and a method using polarizing filters.

As the display device 102, an image display device with motion parallax and without binocular parallax may be used. However, when using this type of image display device, the virtual object needs to be displayed inside from the image display device.

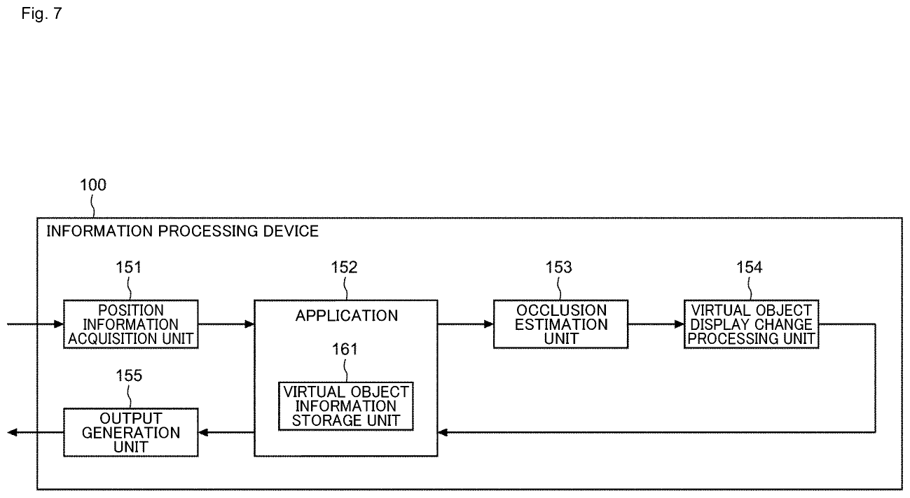

FIG. 7 is a block diagram illustrating a configuration example of the information processing device 100 of FIG. 6.

As illustrated in FIG. 7, the information processing device 100 includes a position information acquisition unit 151, an application 152, an occlusion estimation unit 153, a virtual object display change processing unit 154, and an output generation unit 155. The application 152 includes a virtual object information storage unit 161.

For example, the position information acquisition unit 151, the occlusion estimation unit 153, the virtual object display change processing unit 154, and the output generation unit 155 are included in the functions of the processing unit 111 in FIG. 6, and operate under the control of the control unit 110 in FIG. 6.

The application 152 is an application for providing a CG space using a CAVE, such as a virtual room, a virtual exhibition, a virtual live performance, or a game. The application 152 is implemented by the control unit 110 in FIG. 6 executing a program, and each unit performs various types of processing in cooperation with the application 152. The virtual object information storage unit 161 is included in the storage unit 112 of FIG. 6, and records therein information on virtual objects used by the application 152.

The position information acquisition unit 151 acquires position information of real objects such as users and objects, based on the sensor information input from the sensor 101. The position information of the real objects is supplied to the occlusion estimation unit 153 via the application 152. The application 152 supplies information on virtual objects to the occlusion estimation unit 153 and the virtual object display change processing unit 154. In addition, the position information acquisition unit 151 can supply the sensor information from the sensor 101 to the application 152 as necessary.

Based on the position indicated by the position information of a real object supplied from the position information acquisition unit 151 and the corresponding position in the real space of a virtual object viewed by a user, the occlusion estimation unit 153 estimates whether the virtual object is occluded by the real object (user). The occlusion estimation result is supplied to the virtual object display change processing unit 154.

If the occlusion estimation result supplied from the occlusion estimation unit 153 indicates that the virtual object is occluded by the real object, the virtual object display change processing unit 154 performs display change processing for the virtual object. In the display change processing, the form change of the virtual object is performed. The form change of the virtual object includes a movement of the virtual object and a change in the display form of the virtual object. Information on the form change of the virtual object is supplied to the output generation unit 155 via the application 152.

The output generation unit 155 generates image data of a stereoscopic image to be displayed to a user based on various types of information supplied from the application 152, and outputs the image data to the display device 102. The output generation unit 155 also generates image data of a stereoscopic image to be displayed to the user based on information on a form change of a virtual object supplied from the virtual object display change processing unit 154, and outputs the image data to the display device 102.

### Flow of Processing in System

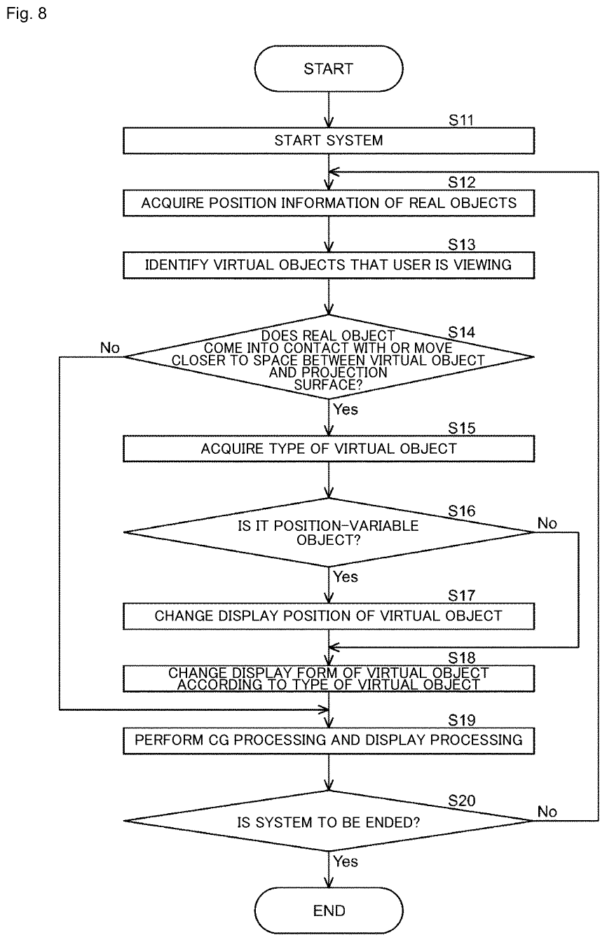

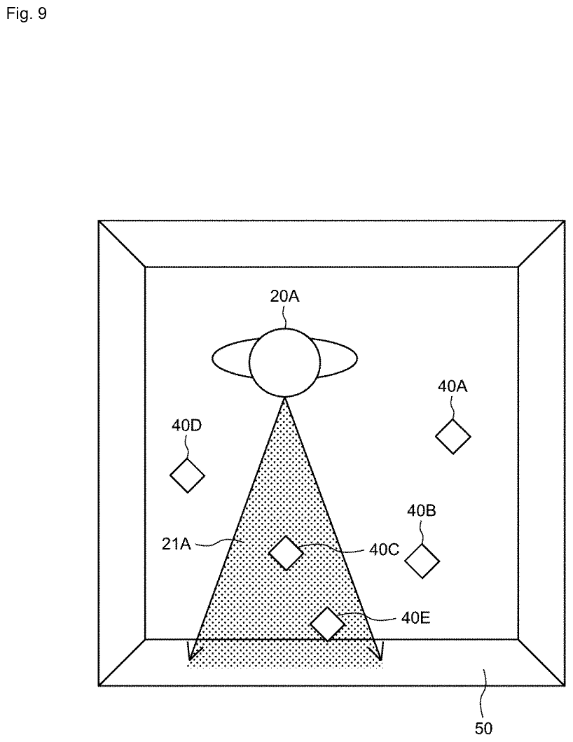

Next, a flow of processing performed by the CAVE system 10 will be described with reference to the flow chart of FIG. 8. For the description of FIG. 8, schematic diagrams in FIGS. 9 to 17 will be referred to as appropriate.

When the CAVE system 10 is started (S11), the information processing device 100 performs the processing of steps S12 to S20.

In step S12, the position information acquisition unit 151 acquires position information of real objects based on the sensor information from the sensor 101. In this example, as position information of a real object, information on a three-dimensional position and orientation of a user in the real space can be obtained based on the sensor information.

In step S13, the occlusion estimation unit 153 identifies, based on the information on the real object and information on virtual objects, virtual objects that the user is viewing (gazing at).

For example, as illustrated in a top view of FIG. 9, by acquiring the gaze of a user 20A based on sensor information from a real object distance measurement sensor, virtual objects 40 within a field of view 21A of the user 20A can be identified. In the example of FIG. 9, among virtual objects 40A to 40E, the virtual objects 40C and 40E are identified as virtual objects 40 that are within the field of view 21A of the user 20A and the user 20A is viewing.

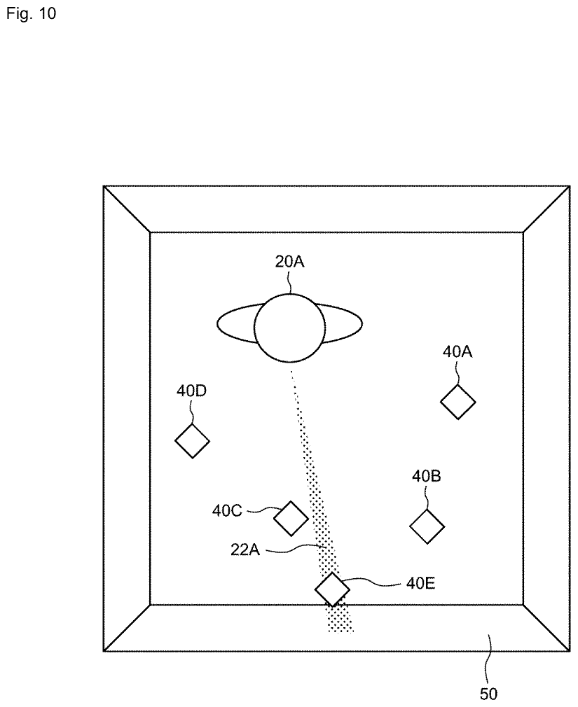

As illustrated in a top view of FIG. 10, by using sensor information from an infrared sensor or a gaze estimation sensor through image processing and the like, the gaze of a user 20A can be estimated more precisely and a virtual object 40 that the user 20A is gazing at can be identified. In the example of FIG. 10, among virtual objects 40A to 40E, the virtual object 40E is located within a gaze region 22A and is identified as a virtual object 40 being gazed at.

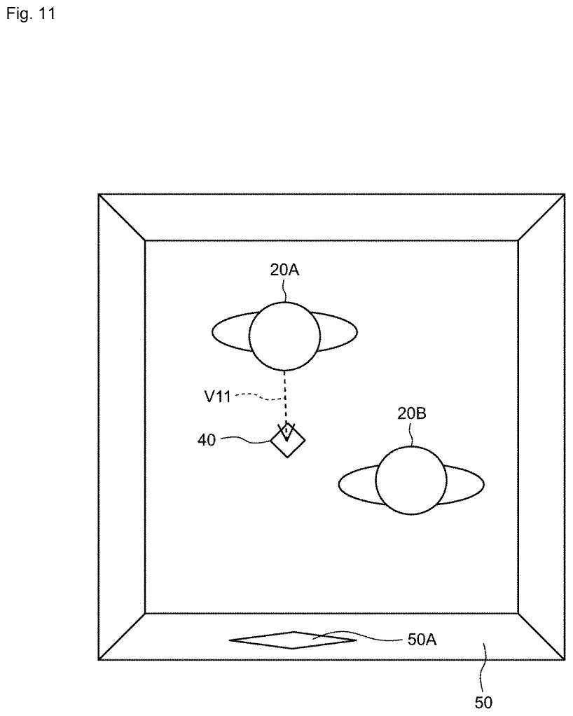

Returning to FIG. 8, in step S14, the occlusion estimation unit 153 determines whether a real object comes into contact with or moves closer to a space between a virtual object and the projection surface. For example, the contact or close movement can be determined by an estimation method illustrated in FIGS. 11 to 15.

FIGS. 11 to 15 illustrate top views of states in which a user 20A is stereoscopically viewing a virtual object 40 projected onto a projection surface 50 while a user 20B is present in the vicinity of the user 20A. First, as illustrated in FIG. 11, a vector V11 from the user 20A to the virtual object 40 is calculated.

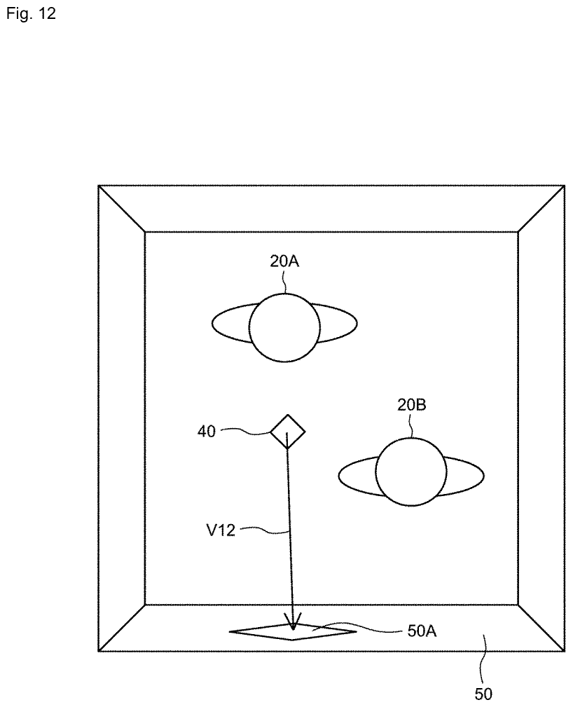

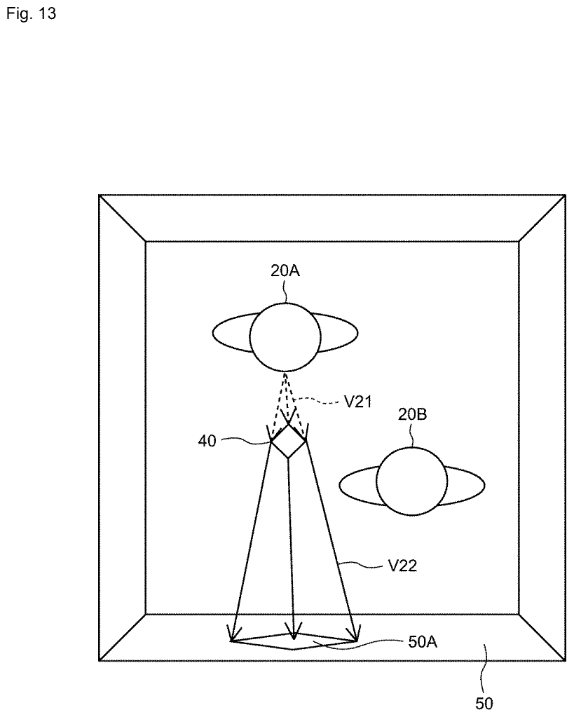

Next, as illustrated in FIG. 12, a vector V12 (hereinafter referred to as an occlusion vector V12) from the virtual object 40 to the projection surface 50 in the same direction as the vector V11 is calculated. As illustrated here in FIG. 13, a vector V21 corresponding to the outline of the virtual object 40 when viewed from the user 20A may be calculated, and an occlusion vector V22 corresponding to the outline of the virtual object 40 may be calculated based on the vector V21. Instead of the above-described vectors (three-dimensional vectors), a light ray may be used, for example.

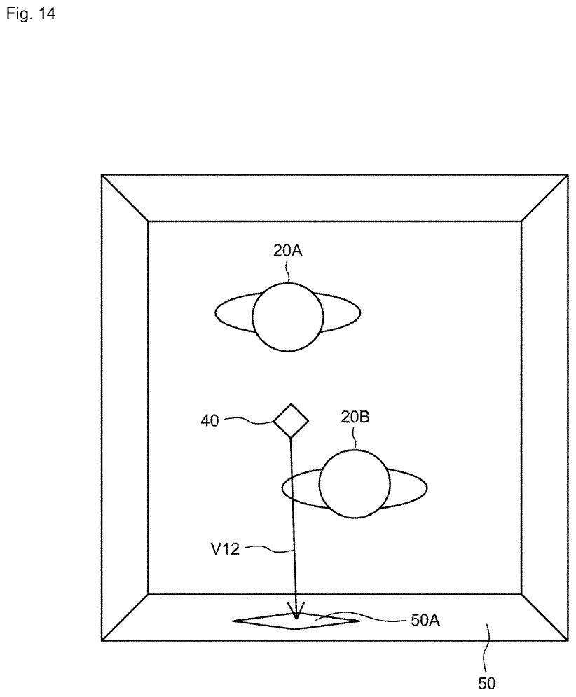

Next, as illustrated in FIG. 14, a determination is made whether the user 20B collides with the occlusion vector V12, and the occlusion vector V12 and the user 20B being in a contact state is determined as the virtual object 40 is in an occluded state. In the example of FIG. 14, since the user 20B is in contact with the occlusion vector V12, the virtual object 40 is in an occluded state.

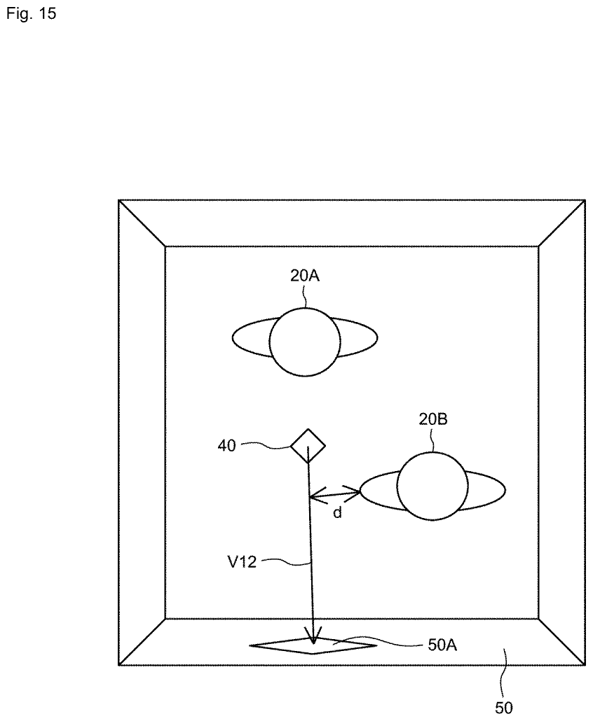

As illustrated in FIG. 15, the close movement of the user 20B can be detected based on a distance d between the occlusion vector V12 and the user 20B. In this example, when the user 20B moves closer to within a predetermined distance, the virtual object 40 is in a state where it is occluded by the user 20B, and this state can be detected. In this way, by detecting the close movement of the user 20B using the distance d, the occluded state of the virtual object 40 can be estimated more precisely.

In this example, the vector V11 directed from the user 20A toward the virtual object 40 is calculated based on the position indicated by the position information of the user 20A and the corresponding position in the real space of the virtual object. Furthermore, the occlusion vector V12 directed from the virtual object 40 toward the projection surface 50 is calculated based on the vector V11. Then, depending on whether the occlusion vector V12 and the position indicated by the position information of the user 20B are in contact with or close to each other, it is determined whether or not the virtual object 40 is occluded by the user 20B. The corresponding position in the real space of the virtual object is managed by the application 152 and recorded in the virtual object information storage unit 161 as appropriate so that it can be acquired as necessary.

Returning to FIG. 8, if it is determined in step S14 that a real object comes into contact with or moves closer to a space between the virtual object and the projection surface, the processing proceeds to step S15. Hereinafter, such a virtual object that a real object comes in contact with or moves closer to a space between the virtual object and the projection surface is also referred to as a virtual object in an occluded state.

In step S15, the virtual object display change processing unit 154 acquires the type of the virtual object in the occluded state. In step S16, the virtual object display change processing unit 154 determines, based on the type of the virtual object in the occluded state, whether or not the virtual object in the occluded state is a position-variable object which is a virtual object whose display position can be changed.

If it is determined in step S16 that the virtual object in the occluded state is a position-variable object, the processing proceeds to step S17. In step S17, the virtual object display change processing unit 154 changes the display position of the virtual object in the occluded state. In changing the display position, the display position of the virtual object is changed by, for example, translation, to move the virtual object in the occluded state.

When the processing of step S17 ends, the processing proceeds to step S18. If it is determined in step S16 that the virtual object in the occluded state is not a position-variable object, the processing of step S17 is skipped and then the processing proceeds to step S18.

In step S18, the virtual object display change processing unit 154 changes the display form of the virtual object in the occluded state according to the type of the virtual object in the occluded state. In changing the display form, the display form of the virtual object in the occluded state is changed by, for example, change from stereoscopic displaying to planar displaying.

In this way, when a virtual object that a user is viewing (gazing at) is occluded by a real object, display change processing is performed depending on whether or not the virtual object is a position-variable object. Whether a virtual object is a position-variable object can be determined by, for example, a designer of the system, depending on whether or not the designer feels discomfort when the virtual object moves.

Examples of a virtual object that does not create a sense of discomfort even when the virtual object moves, that is, a virtual object whose display position may change, include a graphical user interface (GUI) such as menu display, a virtual object that is not linked to a CG world (e.g., a preview in 3D model production), an assistant character (e.g., a fairy), and a performer in a virtual live performance (e.g., a virtual idol).

In the display change processing for a virtual object that does not create a sense of discomfort even when the virtual object moves, the virtual object is determined to be a position-variable object (Yes in S16), and the display position and display form of the virtual object are changed (S17, S18). Thus, the display position of the virtual object in the occluded state is changed so that the position of the virtual object is moved, and the display form is also changed. The movement of the position includes not only translation but also movement with size enlargement/reduction and deformation of the virtual object.

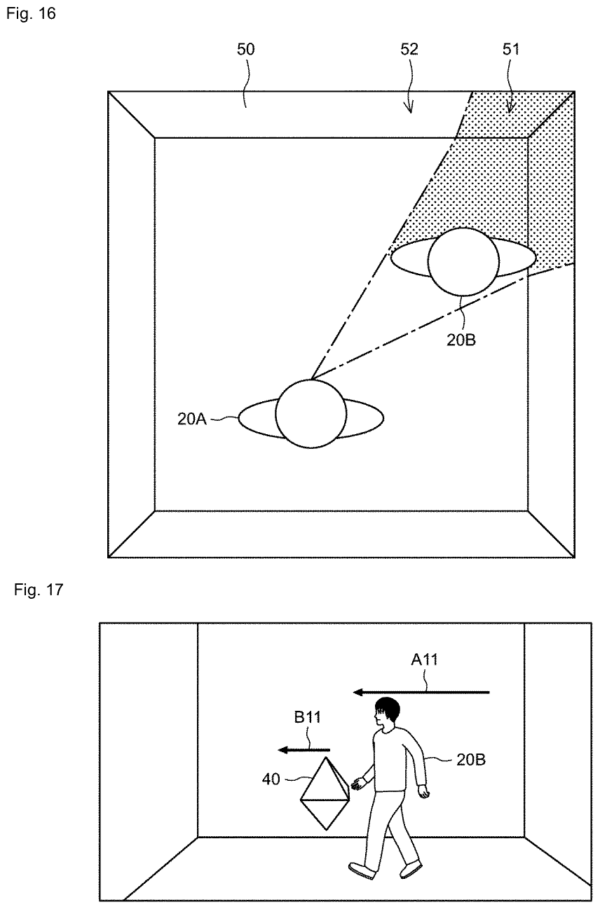

In changing the display position, the virtual object in the occluded state is moved so that it can be viewed by the target user. As illustrated in a top view of FIG. 16, when a region (a dotted region in the figure) corresponding to a projection surface 50 that is not visible to a user 20B from the viewpoint of a user 20A is set as an occluded region 51, and the other region (the region other than the dotted region in the figure) is set as a non-occluded region 52, virtual objects in the occluded region 51 are moved to the non-occluded region 52.

For example, FIG. 17 is a diagram illustrating a view in which a virtual object 40 is viewed from the viewpoint of the user 20A (user 20A's viewpoint view). As indicated by an arrow B11 in the figure, the virtual object 40 that is in the occluded region has been moved by translation to the non-occluded region that is not occluded by the other user 20B. Accordingly, the user 20A can view the virtual object 40.

At this time, the virtual object 40 may not only move from the occluded region to the non-occluded region, but may also move to avoid the occluded region as the user 20B moves closer to the occluded region, as indicated by an arrow A11 in the figure. Alternatively, when the virtual object 40 moves a predetermined distance or more, and its position before the movement (original position) is in the non-occluded region, the virtual object 40 may return to the position before the movement. In other words, as the user 20B moves, the original position changes from the occluded region to the non-occluded region, so that the virtual object 40 can be returned to the original position.

In changing the display form, after the virtual object in the occluded state moves, processing such as effects can be applied to inform the user of the position of the virtual object after the movement. For example, the virtual object may be made to blink or emit light after the movement, or the path of the virtual object's movement may be displayed.

On the other hand, examples of a virtual object that can move and create a sense of discomfort as a result of its movement, that is, a virtual object whose display position should not change, include an item placed at a specific position on a map in a game, furniture in a virtual room, an exhibit at a virtual exhibition (including a metaverse exhibition), a game creature, and an online user.

In the display change processing for a virtual object that creates a sense of discomfort when the virtual object moves, the virtual object is determined not to be a position-variable object (No in S16), and the display form of the virtual object is changed (S18). Thus, the display position of the virtual object in the occluded state is not changed, and only the display form is changed. In changing the display form, it is possible to change the virtual object in the occluded state from stereoscopic displaying to planar displaying, or to display various types of information for informing the user of the virtual object in the occluded state.

Information on the type of a virtual object and a position-variable object (movable object) may be registered in advance for each 3D object, or may be acquired as needed by performing estimation processing using a machine-learned model.

The display change processing may not be performed for a specific virtual object. Examples of a virtual object that is not subjected to the display change processing include particles such as bullets and rain used in a game, an object that moves at a certain speed or faster, and effects. Even for a virtual object that is subject to the display change processing, the processing may not be performed under the following conditions, for example: a case where there is no range in which the virtual object can be transitioned (or a range in which the virtual object can be transitioned is small) due to reasons such as users being close to each other or a large number of users being present; and a case where there are a large number of virtual objects that are subject to the display change processing. Furthermore, for a virtual object with a low priority in a case where virtual objects are assigned priorities for the display change processing, and for a case where a movement condition is not satisfied for another display change processing, the processing does not need to be performed.

When the processing of step S18 ends, the processing proceeds to step S19. If it is determined in step S14 that a real object does not come in contact with or move closer to a space between the virtual object and the projection surface, the processing of steps S15 to S18 is skipped and then the processing proceeds to step S19.

In step S19, the application 152 and the output generation unit 155 perform CG processing and display processing. In the CG processing, processing required to generate a CG space that reflects the series of processing described above is performed. In the display processing, processing required to generate image data of a stereoscopic image to be displayed to the user is performed based on, for example, information obtained in the CG processing. The image data is output to the display device 102, and the display device 102 displays the stereoscopic image based on the image data.

In step S20, it is determined whether or not the CAVE system 10 is to be ended. If it is determined in step S20 that the CAVE system 10 is not to be ended, the processing returns to step S12 to repeat the above-described processing. On the other hand, if it is determined in step S20 that the CAVE system 10 is to be ended, the series of processing ends.

The flow of processing in the CAVE system 10 has been described above. In the CAVE system 10, the information processing device 100 performs, for example, the following processing. That is, the position information acquisition unit 151 acquires first position information indicating a position of a user 20A and second position information indicating a position of a user 20B, the control unit 110 controls, based on a corresponding position in a real space of a virtual object 40 viewed by the user 20A and the position indicated by the second position information of the user 20B, controls a form change of the virtual object 40, and the output generation unit 155 outputs a stereoscopic image to be displayed to the user 20A and the user 20B based on the form change of the virtual object 40. Such a form change of the virtual object 40 makes it possible to reduce adverse effects caused by a real object, such as another user, occluding the virtual object 40 when a plurality of users, such as the user 20A and the user 20B, are experiencing the CAVE system 10.

The control unit 110 can control the form change of the virtual object 40 when the virtual object 40 viewed by the user 20A is determined to be occluded by the user 20B. In particular, the virtual object 40 is projected onto a projection surface 50 so that the user 20A stereoscopically views the virtual object 40, and when the user 20B comes into contact with or moves closer to a space between the virtual object 40 and the projection surface 50, the occlusion estimation unit 153 determines that the virtual object 40 is occluded by the user 20B. The form change of the virtual object 40 includes a movement of the virtual object and a change in the display form of the virtual object. Details of the movement of the virtual object and the change in the display form of the virtual object will be described below.

### Movement of Virtual Object

The movement of a virtual object is achieved by changing the display position in the display change processing. For example, the following steps of processing (a) to (e) can be performed to move a virtual object.
(a) For the movement, move the virtual object with varying speed.
(b) Switch between movement and avoidance of the virtual object depending on the state of close movement to a non-occluded region.
(c) Move the virtual object to upper and lower regions which are non-occluded regions.
(d) Autonomously move the virtual object if it is a virtual object whose position can be changed autonomously.
(e) If there are a plurality of target virtual objects, move the plurality of virtual objects according to relationships between them.

### (a) Movement With Varying Speed

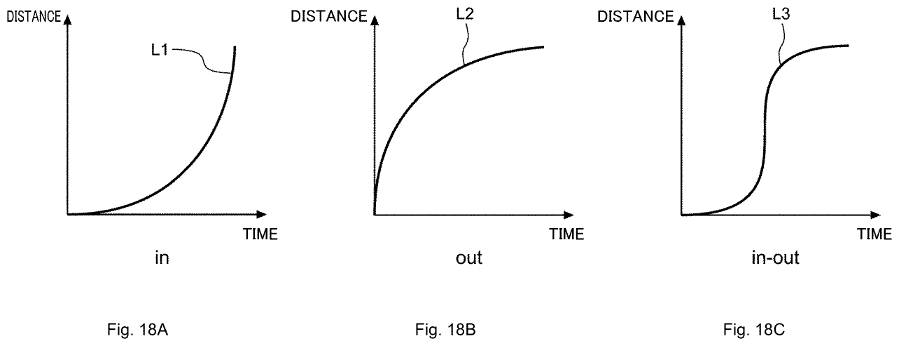

For the movement of a virtual object, the virtual object is not moved instantaneously, but is moved with varying speed (easing). FIG. 18 is a diagram illustrating an example of a virtual object moving with varying speed. In FIG. 18, A to C show trajectories of ease-in and ease-out in easing, with the horizontal axis representing time and the vertical axis representing distance. Ease-in means acceleration, which is a movement that starts slowly and then gets faster. Ease out means deceleration, which is a movement that starts fast and slows down towards the end.

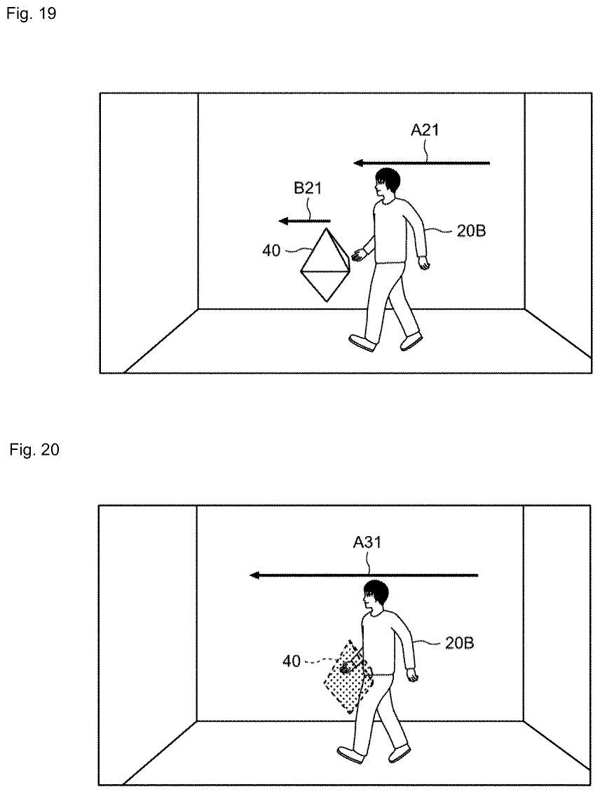

In FIG. 18, A indicates a curve L1 in which the virtual object accelerates (in). In FIG. 18, B indicates a curve L2 in which the virtual object decelerates (out). In FIG. 18, C indicates a curve L3 in which the virtual object accelerates and decelerates (in-out). For example, as illustrated in a viewpoint diagram (user 20A's viewpoint diagram) in FIG. 19, the virtual object 40 can move (an arrow B21 in the figure) with varying speed as the user 20B moves closer to the virtual object 40 (an arrow A21 in the figure).

However, for a virtual object on which input actions such as selection are performed through a user interface (UI), discrete movement is used. If such a virtual object were to move with varying speed, it would be difficult to perform input actions. In this case, to inform the user of the discrete movement, the object fades out once, and a notification effect is used when it fades in in a non-occluded region (at a different position).

The virtual object may fade out once, and then fade in at the same position after another user passes by. For example, as illustrated in a viewpoint diagram (user 20A's viewpoint diagram) in FIG. 20, the virtual object 40 fades out, but after the user 20B passes by, the virtual object 40 can fade in to be displayed at the same position as the user 20B moves closer to the virtual object 40 (an arrow A31 in the figure). In this example, the virtual object 40 fades out or fades in based on the corresponding position in the real space of the virtual object 40 and the position indicated by the position information of the user 20B.

### (b) Switching Between Movement and Avoidance

When a real object such as another user attempts to occlude a virtual object, there are two types of movement methods: movement and avoidance of the virtual object. The movement here refers to the virtual object simply avoiding the real object such as the other user that attempts to occlude. The avoidance refers to the virtual object going around the real object such as the other user from behind and returning to its original position (initial position). The movement and avoidance are switched depending on the state of movement of the real object closer to a non-occluded region (e.g., the moving speed and moving position of the other user).

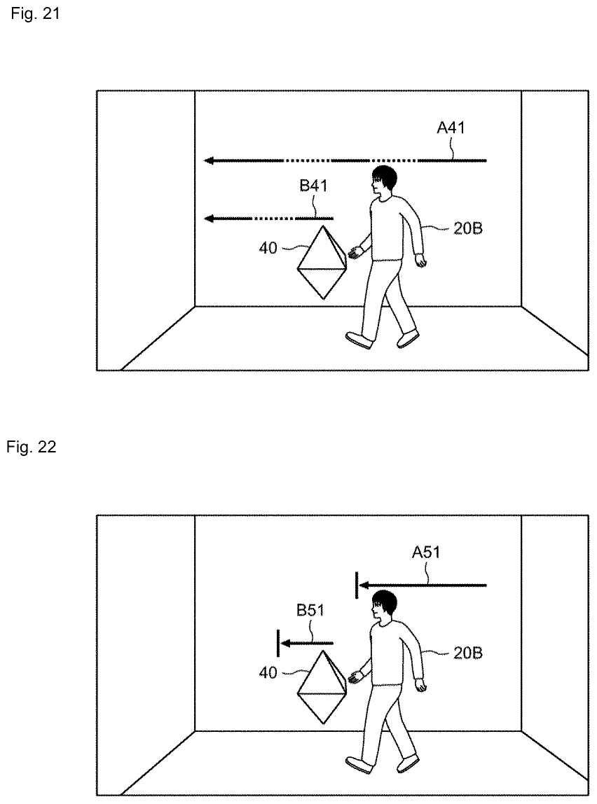

As illustrated in a viewpoint diagram (user 20A's viewpoint diagram) in FIG. 21, when the other user 20B moves slowly or intermittently (an arrow A41 in the figure), the virtual object 40 is moved accordingly (an arrow B41 in the figure). When such movement is taking place, conditions for switching to avoidance include, for example, when the other user 20B moves quickly or when the virtual object 40 passes the initial position, and if either of these conditions is satisfied, the virtual object 40 can be switched from movement to avoidance.

As illustrated in a viewpoint diagram (user 20A's viewpoint diagram) in FIG. 22, when the other user 20B stops midway through movement (an arrow A51 in the figure), the virtual object 40 moves (an arrow B51 in the figure) in response to the other user 20B stopping. This results in the virtual object 40 stopping in response to the other user 20B stopping, without switching to avoidance. After that, when the other user 20B moves slowly or intermittently (in the case of a condition other than avoidance), the virtual object 40 moves accordingly.

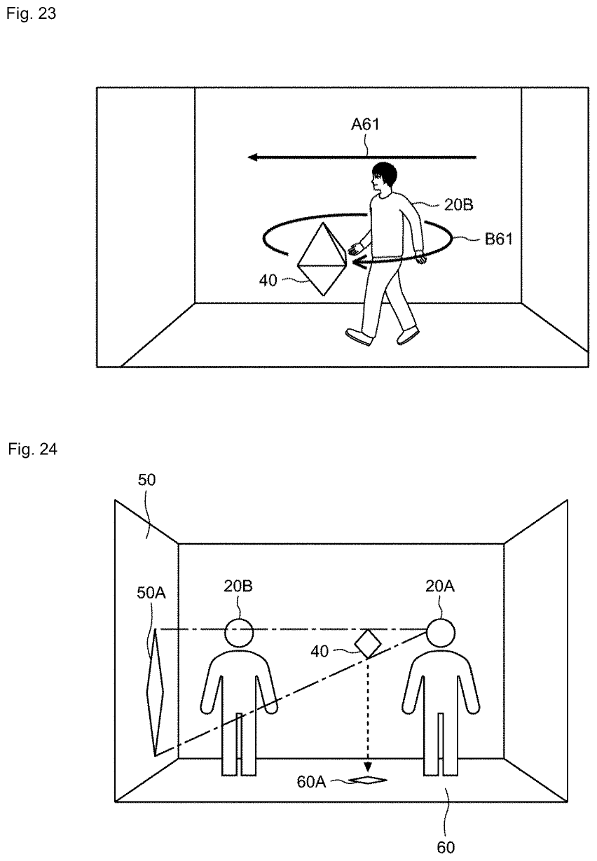

As illustrated in a viewpoint diagram (user 20A's viewpoint diagram) in FIG. 23, when the other user 20B moves quickly (an arrow A61 in the figure) or moves past the initial position of the virtual object 40 (the arrow A61 in the figure), the virtual object 40 is avoided (an arrow B61 in the figure). In the example of FIG. 23, as indicated by the arrow B61, the virtual object 40 moves around the other user 20B from behind and returns to the initial position. When the other user 20B stops midway through movement (in the case of a condition other than avoidance), the virtual object moves or stops accordingly.

### (c) Movement to Upper and Lower Spaces

When there are non-occluded regions in upper and lower regions (vertical regions) in the real space, a virtual object in an occluded region may be moved to the upper or lower region. In other words, the virtual object is not limited to moving in the horizontal direction (translational movement), and may be moved in the vertical or diagonal direction, for example.

### (d) Autonomous Movement

A virtual object whose position may be changed autonomously can be moved autonomously. For example, autonomously movable virtual objects, such as performers in a virtual live performance or virtual robots in a game, can be moved naturally in combination with autonomous movement when moving from an occluded region to a non-occluded region. Specifically, in a virtual live performance, a virtual idol may move into a non-occluded region while dancing.

### (e) Movement for a Case Where There Are a Plurality of Virtual Objects

For a plurality of virtual objects to be subjected to the display change processing, there are the following two types of movement methods depending on whether or not the plurality of virtual objects are related to each other. First, virtual objects that are discrete but related to each other are to be moved while preserving their relative distances. Examples of such a plurality of related virtual objects include those in a CG image of a solar system, a CG image of a city, and a plurality of GUI windows.

Second, virtual objects that are discrete and not related to each other are to be moved in order starting from the virtual object in the center of the user's field of view. If information on the user's gaze has been acquired from the sensor information, virtual objects that the user is viewing may be assigned priorities, and a virtual object with a higher priority may be moved. Examples of such a plurality of unrelated virtual objects include a plurality of items placed on the ground of an in-game map.

### Changing Display Form of Virtual Object

For a virtual object associated with a position, the display form is changed. For the change in the display form, there are two types of processing: planarization processing that changes stereoscopic displaying (3D displaying) of a virtual object occluded by a real object to planer displaying (2D displaying); and notification processing that displays information for notifying of a virtual object occluded by a real object (hereinafter also referred to as notification information). Both the planarization processing and the notification processing may be performed, or only one of the types of processing may be performed.

### (a) Planarization Processing

In the planarization processing, when a real object such as another user occludes a virtual object, the virtual object is displayed on the floor as a planar image (2D image). FIG. 24 illustrates an example in which a virtual object is changed from stereoscopic displaying to planar displaying.

In FIG. 24, a user 20A can view a stereoscopic virtual object 40 through a virtual object 50A projected onto a projection surface 50, but when the stereoscopic virtual object 40 is occluded by a user 20B, it is displayed on a floor surface 60 as a flat image 60A. Thus, the virtual object 40, such as a virtual item whose display position is particularly important, can be changed to planar displaying on the floor surface, allowing the user 20A to reliably confirm the location of the virtual object 40.

At this time, processing such as effects can be performed to inform the user that the virtual object has been changed from stereoscopic displaying to planar displaying. For example, the virtual object may be made to blink or emit light after the display form is changed from stereoscopic displaying to planar displaying, or a trajectory of movement from the stereoscopically displayed virtual object to a planarly displayed virtual object may be displayed. Even for a movable virtual object, the virtual object may be made planar, for example, when another user moves frequently or in an event scene. The virtual object to be planarly displayed (a planar image) may be displayed on a surface other than the floor.

### (b) Notification Processing

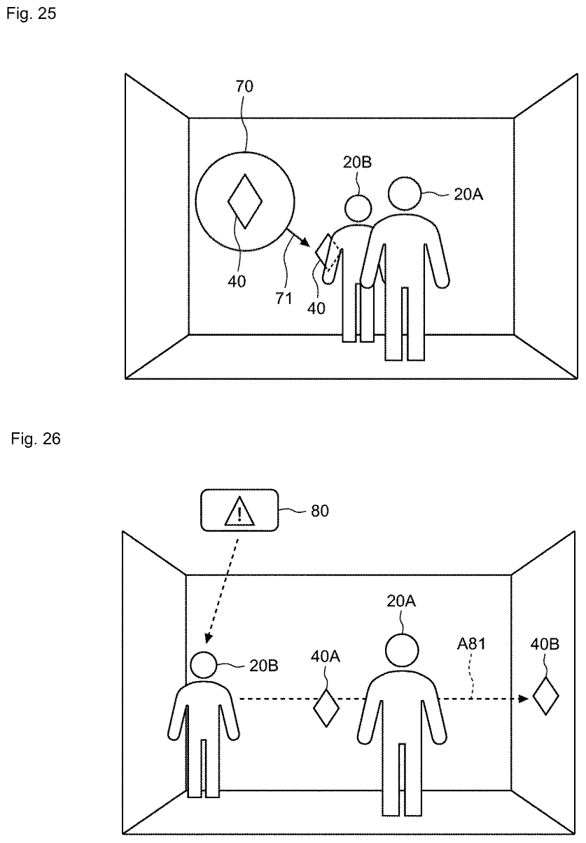

In the notification processing, when a real object such as another user occludes a virtual object, notification information (e.g., a window representing the virtual object) is displayed to inform the user of the occluded virtual object. FIG. 25 illustrates an example of displaying notification information for informing of a virtual object.

In FIG. 25, a virtual object 40 is occluded by a user 20B, so that a user 20A cannot view the virtual object 40. At this time, a window 70 representing the virtual object 40 is displayed in a non-occluded region as notification information, thereby making it possible to inform the user 20A of the virtual object 40 that is occluded by the user 20B. For example, the window 70 can be displayed stereoscopically in the non-occluded region, and an arrow 71 indicating the position of the virtual object 40 can be displayed. Thus, it is possible to inform the user 20A of the presence of the virtual object 40 such as an important virtual item even when the virtual object 40 is occluded by the user 20B.

### MODIFICATION EXAMPLE

### Another Example of Display Change Processing

The display change processing can achieve processing for preventing occlusion by another user. Specifically, when there is a risk that a virtual object being viewed by a user may be occluded by another user, display change processing for the other user to avoid occlusion is performed to prevent the virtual object from being occluded. As the display change processing for another user, there are, for example, the following two types of methods depending on whether or not a virtual object viewed by the other user is movable.

First, if a virtual object viewed by another user is not movable, a warning is displayed to the other user. For example, as illustrated in FIG. 26, it is given that, when a user 20A is viewing a virtual object 40A and a user 20B is viewing a virtual object 40B, the user 20B moves closer to the virtual object 40A to move toward the virtual object 40B, as indicated by an arrow A81 in the figure. The virtual object 40B that the user 20B is viewing is not movable.

In this situation, a dialog box 80 containing a warning is displayed to the user 20B. Thus, it is possible to make the user 20B aware that if the user 20B continues moving in this manner, the virtual object 40A will be occluded. In the example of FIG. 26, the dialog box 80 is displayed to the user 20B. However, display is not limited to this example, and for example, a CG to prompt the user 20B to avoid, such as magma or an enemy character in a game, may be displayed at the corresponding position in the real space of the virtual object 40A.

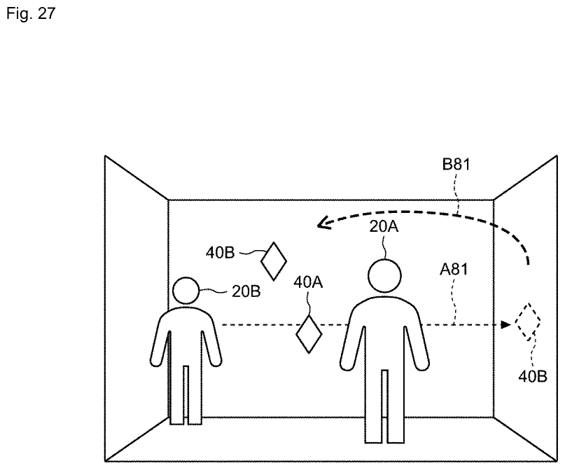

Second, if a virtual object that another user is viewing is movable, the virtual object is moved. For example, in FIG. 27, similar to FIG. 26, while a user 20A and a user 20B are each viewing a different virtual object 40, the user 20B moves closer to a virtual object 40A, and a virtual object 40B that the user 20B is viewing is movable. In this situation, the virtual object 40B is moved from the position of a dashed line to the position of a solid line, as indicated by an arrow B81 in the figure. For example, the corresponding position in the real space of the virtual object 40B is moved to a position in the vicinity of the user 20B. This allows the user 20B to move closer to the virtual object 40B without passing through a position that occludes the virtual object 40A.

### Other Application Examples of Movement of Virtual Object

The movement of a virtual object includes two types of movement: translation and rotation. For example, in a game or the like, the above-described movement of a virtual object can be applied to the movement of a UI for displaying an inventory or a menu. Furthermore, in a game or the like, when a 3D item held by a user is displayed, the above-described movement of a virtual object can be applied to the movement of the 3D item.

For example, in a discussion using 3D CAD models in a metaverse, the above-described movement of a virtual object can be applied to the movement of a 3D CAD model shared by a plurality of users. In addition, when a plurality of users participate in a virtual live performance using a CAVE system, if occlusion is about to occur on a virtual performer, the virtual performer may move to a non-occluded region by walking.

### Other Application Examples of Change in Display Form of Virtual Object

The change in the display form of a virtual object may be applied to items, creatures, online users, and the like, which can be held based on their position in a game or the like. That may also be applied to virtual exhibits, products, and the like, which are arranged based on their position at metaverse exhibitions and the like.

### Advanced Examples

A projection may be made so as to correspond to the unevenness of an object and enable stereoscopic view. According to the projection that corresponds to the unevenness of an object, if there is a projection onto a real object, the projection is made so as to enable stereoscopic view, taking into account the surface position of the real object. However, in an example here, a projector that projects an occluded virtual object can be used. A projector may be prepared to provide a projection onto the real object when the virtual object is occluded.

When a real object such as another user occludes a virtual object, the virtual object may be displayed on a device held by the user instead of moving the virtual object. Examples of the device include a head mounted display (HMD) and an augmented reality (AR) device using a smartphone.

The technique of the present disclosure may be applied to a display change for avoiding that another user occludes a virtual object in a real space where a non-stereoscopic projection is being made (a room of a non-CAVE system). The technique of the present disclosure may be applied not only to vision but also to stereophonic sound, for example, as a moving technique for sound source localization to avoid that a virtual sound source is occluded. Instead of moving a virtual object away from a real object, a performance may be provided in which the virtual object is intentionally drawn closer to the real object. For example, if another user acquires an item in a game, the acquired item can be sucked into the other user, or a virtual tail-catching game can be played in which a virtual object is placed over the user.

### Configuration Example of Computer

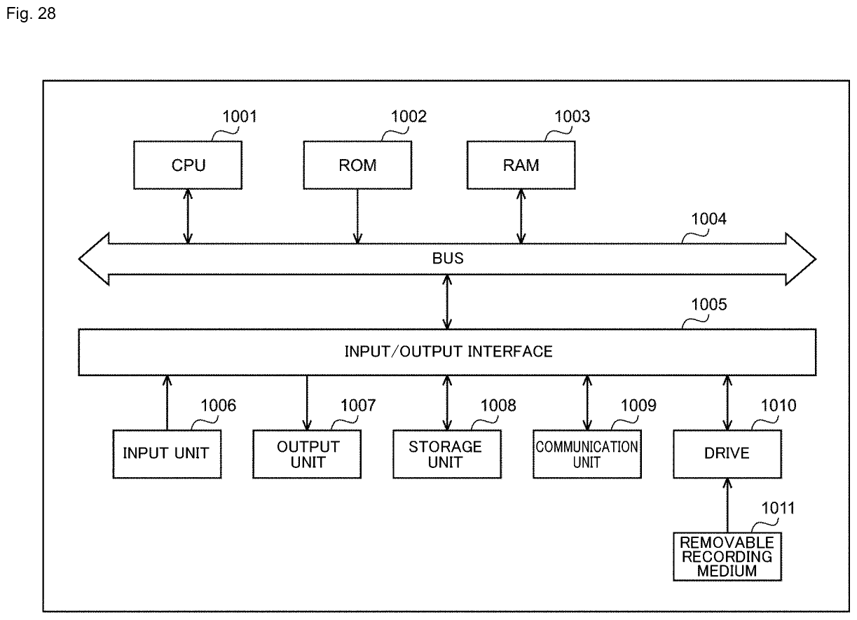

The above-described series of processing can also be performed by hardware or software. In a case where the series of processing is performed by software, a program that configures the software is installed on a computer. FIG. 28 is a block diagram illustrating a configuration example of computer hardware that performs the above-described series of processing using a program.

In the computer, a CPU 1001, a read-only memory (ROM) 1002, and a random access memory (RAM) 1003 are connected to one another via a bus 1004. An input/output interface 1005 is further connected to the bus 1004. An input unit 1006, an output unit 1007, a storage unit 1008, a communication unit 1009, and a drive 1010 are connected to the input/output interface 1005.

The input unit 1006 includes a keyboard, a mouse, a microphone, and the like. The output unit 1007 includes a display, a speaker, and the like. The storage unit 1008 includes for example a hard disk and a non-volatile memory. The communication unit 1009 may be a network interface. The drive 1010 drives a removable recording medium 1011 such as a semiconductor memory, a magnetic disk, an optical disc, or a magneto-optical disk.

In the computer configured as described above, the CPU 1001 loads, for example, a program recorded in the ROM 1002 or the storage unit 1008 into the RAM 1003 via the input/output interface 1005 and the bus 1004, and executes the program so that the above-described series of processing are performed.

The program to be executed by the computer (the CPU 1001) can be provided in such a manner as to be recorded on, for example, the removable recording medium 1011 serving as a packaged medium. The program can be supplied via a wired or wireless transmission medium such as a local area network, the Internet, or digital satellite broadcasting.

In the computer, by mounting the removable recording medium 1011 on the drive 1010, it is possible to install the program in the storage unit 1008 via the input/output interface 1005. The program can be received by the communication unit 1009 via a wired or wireless transmission medium to be installed in the storage unit 1008. In addition, the program can be installed in advance in the ROM 1002 or the storage unit 1008.

The processing performed by the computer in accordance with the program described herein may not necessarily be performed chronologically in the order described as the flowcharts. In other words, the processing performed by the computer in accordance with the program also includes processing that is performed in parallel or individually (e.g., parallel processing or processing by objects).

In addition, a program may be processed by a single computer (processor) or may be processed by a plurality of computers in a distributed manner. Further, the program may be transmitted to a remote computer and executed there.

Each step described in the above flowchart can be performed by one device or executed in a shared manner by a plurality of devices. Furthermore, in a case in which one step includes a plurality of processes, the plurality of processes included in the one step can be performed by one device or performed in a shared manner by a plurality of devices.

Embodiments of the present disclosure are not limited to those described above and can be modified in various manners without departing from the gist of the present disclosure. For example, the embodiments of the present disclosure may be configured through cloud computing in which a plurality of devices share and cooperatively process one function over a network. Specifically, at least some of the functions of the configuration example of the information processing device 100 in FIG. 7 may be provided for a cloud server.

The advantageous effects described in the present specification are merely exemplary and are not limited, and other advantageous effects may be achieved.

The present disclosure can be configured as follows.
(1)

An information processing device including:
a position information acquisition unit that acquires first position information indicating a position of a first user and second position information indicating a position of a second user;
a control unit that controls, based on a corresponding position in a real space of a virtual object viewed by the first user and the position indicated by the second position information, a form change of the virtual object; and
an image output unit that outputs a stereoscopic image to be displayed to the first user and the second user based on the form change of the virtual object.
(2)

The information processing device according to (1), wherein the control unit controls the form change of the virtual object when the virtual object is determined to be occluded by the second user.
(3)

The information processing device according to (2), wherein
the virtual object is projected onto a projection surface so that the first user stereoscopically views the virtual object, and
when the second user comes into contact with or moves closer to a space between the virtual object and the projection surface, the virtual object is determined to be occluded by the second user.
(4)

The information processing device according to (3), wherein the control unit controls the form change of the virtual object based on a type of the virtual object.
(5)

The information processing device according to any one of (1) to (4), wherein the form change of the virtual object includes a movement of the virtual object and a change in a display form of the virtual object.
(6)

The information processing device according to (5), wherein the control unit moves the virtual object so as to vary speed by at least one of acceleration and deceleration.
(7)

The information processing device according to (5), wherein the control unit fades out or fades in the virtual object based on the corresponding position in the real space of the virtual object and the position indicated by the second position information.
(8)

The information processing device according to (5), wherein the control unit switches between a first movement in which the virtual object is moved so as to avoid the second user and a second movement in which the virtual object is moved so as to avoid the second user by going around the second user and returning to an original position, based on the corresponding position in the real space of the virtual object and the position indicated by the second position information.
(9)

The information processing device according to (8), wherein the control unit switches between the first movement and the second movement based on a moving speed or a moving position of the second user.
(10)

The information processing device according to (5), wherein, when the virtual object is autonomously movable, the control unit moves the virtual object along with autonomous movement.
(11)

The information processing device according to (5), wherein, when there are a plurality of the virtual objects, the control unit moves the virtual object based on relationships between the plurality of the virtual objects.
(12)

The information processing device according to (5), wherein the control unit changes the display form of the virtual object occluded by the second user from stereoscopic displaying to planar displaying.
(13)

The information processing device according to (5), wherein the control unit displays notification information for notifying the first user of the virtual object occluded by the second user.
14)

The information processing device according to (1), wherein, when the first user is viewing the first virtual object and the second user is viewing the second virtual object, and when the second virtual object is not movable, the control unit displays a warning to the second user when the first virtual object is likely occluded by the second user.
(15)

The information processing device according to (1), wherein, when the first user is viewing the first virtual object and the second user is viewing the second virtual object, and when the second virtual object is movable, the control unit moves the second virtual object to a vicinity of the second user when the first virtual object is likely occluded by the second user.
(16)

The information processing device according to (3), wherein the control unit
calculates a first vector from the first user toward the virtual object based on the position indicated by the first position information and the corresponding position in the real space of the virtual object,
calculates a second vector from the virtual object toward the projection surface based on the first vector; and
determines whether the virtual object is occluded by the second user based on whether the second vector and the position indicated by the second position information are in contact with or close to each other.
(17)

The information processing device according to (16), wherein the first vector and the second vector correspond to an outline of the virtual object.
(18)

The information processing device according to any one of (1) to (17), constituting a CAVE system.
(19)

An information processing method including:
acquiring first position information indicating a position of a first user and second position information indicating a position of a second user;
controlling, based on a corresponding position in a real space of a virtual object viewed by the first user and the position indicated by the second position information, a form change of the virtual object; and
outputting a stereoscopic image to be displayed to the first user and the second user based on the form change of the virtual object.
(20)

A recording medium having a program recorded thereon, the program causing a computer to function as:
a position information acquisition unit that acquires first position information indicating a position of a first user and second position information indicating a position of a second user;
a control unit that controls, based on a corresponding position in a real space of a virtual object viewed by the first user and the position indicated by the second position information, a form change of the virtual object; and
an image output unit that outputs a stereoscopic image to be displayed to the first user and the second user based on the form change of the virtual object.

### REFERENCE SIGNS LIST

10 CAVE system
100 Information processing device
101 Sensor
102 Display device
110 Control unit
111 Processing unit
112 Storage unit
151 Position information acquisition unit
152 Application
153 Occlusion estimation unit
154 Virtual object display change processing unit
155 Output generation unit
161 Virtual object information storage unit
1001 CPU

1. An information processing device comprising:
a position information acquisition unit that acquires first position information indicating a position of a first user and second position information indicating a position of a second user;
a control unit that controls, based on a corresponding position in a real space of a virtual object viewed by the first user and the position indicated by the second position information, a form change of the virtual object; and
an image output unit that outputs a stereoscopic image to be displayed to the first user and the second user based on the form change of the virtual object.

2. The information processing device according to claim 1, wherein the control unit controls the form change of the virtual object when the virtual object is determined to be occluded by the second user.

3. The information processing device according to claim 2, wherein the virtual object is projected onto a projection surface so that the first user stereoscopically views the virtual object, and
when the second user comes into contact with or moves closer to a space between the virtual object and the projection surface, the virtual object is determined to be occluded by the second user.

4. The information processing device according to claim 3, wherein the control unit controls the form change of the virtual object based on a type of the virtual object.

5. The information processing device according to claim 4, wherein the form change of the virtual object includes a movement of the virtual object and a change in a display form of the virtual object.

6. The information processing device according to claim 5, wherein the control unit moves the virtual object so as to vary speed by at least one of acceleration and deceleration.

7. The information processing device according to claim 5, wherein the control unit fades out or fades in the virtual object based on the corresponding position in the real space of the virtual object and the position indicated by the second position information.

8. The information processing device according to claim 5, wherein the control unit switches between a first movement in which the virtual object is moved so as to avoid the second user and a second movement in which the virtual object is moved so as to avoid the second user by going around the second user and returning to an original position, based on the corresponding position in the real space of the virtual object and the position indicated by the second position information.

9. The information processing device according to claim 8, wherein the control unit switches between the first movement and the second movement based on a moving speed or a moving position of the second user.

10. The information processing device according to claim 5, wherein, when the virtual object is autonomously movable, the control unit moves the virtual object along with autonomous movement.

11. The information processing device according to claim 5, wherein, when there are a plurality of the virtual objects, the control unit moves the virtual object based on relationships between the plurality of the virtual objects.

12. The information processing device according to claim 5, wherein the control unit changes the display form of the virtual object occluded by the second user from stereoscopic displaying to planar displaying.

13. The information processing device according to claim 5, wherein the control unit displays notification information for notifying the first user of the virtual object occluded by the second user.

14. The information processing device according to claim 1, wherein, when the first user is viewing the first virtual object and the second user is viewing the second virtual object, and when the second virtual object is not movable, the control unit displays a warning to the second user when the first virtual object is likely occluded by the second user.

15. The information processing device according to claim 1, wherein, when the first user is viewing the first virtual object and the second user is viewing the second virtual object, and when the second virtual object is movable, the control unit moves the second virtual object to a vicinity of the second user when the first virtual object is likely occluded by the second user.

16. The information processing device according to claim 3, wherein the control unit calculates a first vector from the first user toward the virtual object based on the position indicated by the first position information and the corresponding position in the real space of the virtual object,
calculates a second vector from the virtual object toward the projection surface based on the first vector; and
determines whether the virtual object is occluded by the second user based on whether the second vector and the position indicated by the second position information are in contact with or close to each other.

17. The information processing device according to claim 16, wherein the first vector and the second vector correspond to an outline of the virtual object.

18. The information processing device according to claim 1, constituting a CAVE system.

19. An information processing method comprising:
acquiring first position information indicating a position of a first user and second position information indicating a position of a second user;
controlling, based on a corresponding position in a real space of a virtual object viewed by the first user and the position indicated by the second position information, a form change of the virtual object; and
outputting a stereoscopic image to be displayed to the first user and the second user based on the form change of the virtual object.

20. A recording medium having a program recorded thereon, the program causing a computer to function as:
a position information acquisition unit that acquires first position information indicating a position of a first user and second position information indicating a position of a second user;
a control unit that controls, based on a corresponding position in a real space of a virtual object viewed by the first user and the position indicated by the second position information, a form change of the virtual object; and
an image output unit that outputs a stereoscopic image to be displayed to the first user and the second user based on the form change of the virtual object.
